(19) United States
(12) Patent Application Publication
(10) Pub. No.: US 2015/0298497 A1
(43) Pub. Date: Oct. 22, 2015

(54) PERSONALIZED LITHOPHANES AND PROCESSES FOR MAKING THE SAME

(71) Applicant: HALLMARK CARDS, INCORPORATED, Kansas City, MO (US)

(72) Inventors: STEPHEN RICHARD EIKOS, LENEXA, KS (US); GERALD J. HOLLAND, SHAWNEE, KS (US)

(21) Appl. No.: 14/258,836

(22) Filed: Apr. 22, 2014

(51) Int. Cl. B44F 1/06; B44F 5/00; B44F 7/00; B29C 67/00

(52) U.S. Cl. CPC B44F 1/06; B29C 67/0059; B29C 67/0088; B44F 1/066; B44F 5/00; B44F 7/00; B29K 2101/12

(57) ABSTRACT

A lithophane having a 3-dimensional representation of a 2-dimensional image and methods of creating the same are disclosed. The lithophane can include varying thicknesses that correspond to varying levels of shading or darkness in the 2-dimensional image. Portions of the lithophane have a decreased thickness relative to other lithophane portions and correspond to areas of the 2-dimensional image having an increased level of shading or darkness relative to other areas of the 2-dimensional image. The lithophane may be manufactured by way of an automated additive manufacturing process, such as 3-D printing.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present invention relates generally to lithophanes, and more specifically, to lithophanes and the making of lithophanes that include a 3-dimensional representation of a 2-dimensional image.

### BACKGROUND

Generally, lithophanes include an image (similar to a photographic negative) and light passes through the lithophane to reveal the image. In some embodiments the lithophane includes a 3-dimensional image that is illuminated by a light source positioned behind the lithophane. Traditional lithophanes were made such that the thinner portions of the lithophane appeared lighter than the thicker portions, as more light would transmit through the thinner portions of the lithophane material than the thicker portions. While lithophanes may be produced by carving an image out of a porcelain or wax material, a more automated process is desired than can create a high-fidelity 3-dimensional representation of a 2-dimensional image.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In one embodiment of the present invention, a method for forming a 3-dimensional lithophane based on a 2-dimensional image is provided. The method includes receiving a digital representation of a 2-dimensional image, the 2-dimensional image including at least one visibly light portion and at least one visibly dark portion, with the at least one visibly dark portion being visibly darker than the at least one visibly light portion. The method further includes creating a 3-dimensional lithophane based on the digital representation. The lithophane includes opposing front and back sides, the front side including at least a first portion and a second portion. The second portion has a thickness dimension that is greater than a thickness dimension of the first portion. The first portion of the lithophane corresponds to the at least one visibly dark portion of the 2-dimensional image, and the second portion of the lithophane corresponds to the at least one visibly light portion of the 2-dimensional image.

In another embodiment of the present invention, a method for forming a 3-dimensional lithophane based on a 2-dimensional image is provided. The method includes receiving a digital representation of a 2-dimensional image. The 2-dimensional image includes a first area having a first level of shading and a second area having a second level of shading, with the first level of shading being visibly lighter than the second level of shading. The first and second areas define at least a portion of the 2-dimensional image. The method further includes using the digital representation in an automated additive manufacturing process to form a lithophane. The lithophane includes a first portion and a second portion, the first portion having a first thickness and the second portion having a second thickness, the first thickness being greater than the second thickness. The first thickness corresponds to the first area of the 2-dimensional image and the second thickness corresponds to the second area of the 2-dimensional image.

In yet another embodiment of the present invention, a 3-dimensional lithophane based on a 2-dimensional image is provided. The lithophane includes a front side and an opposing back side. The front side includes a 3-dimensional representation of a 2-dimensional image, where the 2 dimensional image includes a first area and a second area that define at least a portion of the 2-dimensional image. The first area has a first level of shading and the second area has a second level of shading, with the first level of shading being visibly lighter than the second level of shading. The 3-dimensional representation includes a first portion and a second portion, the first portion having a first thickness and the second portion having a second thickness, with the first thickness being greater than the second thickness. The first portion of the lithophane corresponds to the first area of the 2-dimensional image and the second portion of the lithophane corresponds to the second area of the 2-dimensional image.

### BRIEF DESCRIPTION OF THE SEVERAL VIEWS OF THE DRAWINGS

The present invention is explained in more detail with reference to the embodiment illustrated in the attached drawing figures, in which like reference numerals denote like elements, in which:

FIG. 1 is a front view of a lithophane in accordance with one embodiment of the present invention;

FIG. 2 is cross-sectional view of the lithophane of FIG. 1 having a backing material coupled to a back side of the lithophane;

FIG. 3 is another cross-sectional view of the lithophane of FIG. 1;

FIG. 4 depicts a flow diagram of an exemplary method for forming a 3-dimensional lithophane based on a 2-dimensional image in accordance with one embodiment of the present invention; and

FIG. 5 depicts a flow diagram of an exemplary method for forming a 3-dimensional lithophane based on a 2-dimensional image in accordance with another embodiment of the present invention.

### DETAILED DESCRIPTION

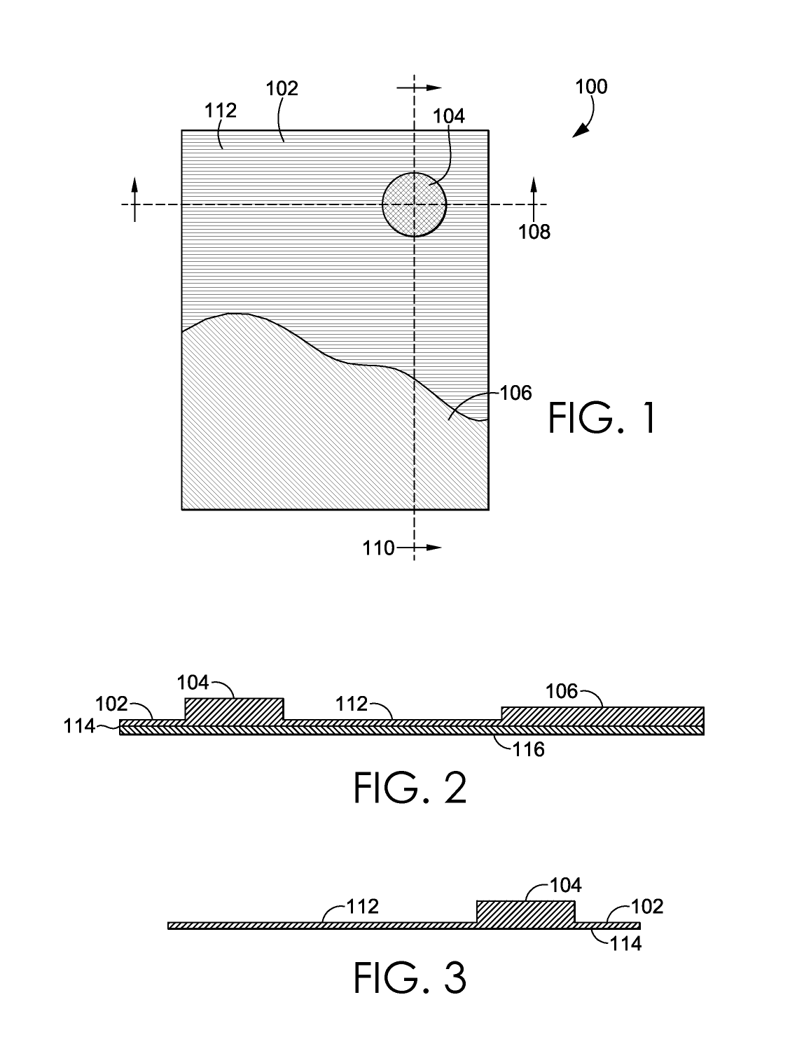

Referring now to the drawings in more detail, wherein like reference characters designate like parts throughout the different views of FIGS. 1-3, and initially to FIG. 1, numeral 100 generally designates a 3-dimensional lithophane constructed in accordance with the present invention. The lithophane 100 can be a 3-dimensional representation of a 2-dimensional image. The 2-dimensional image may contain areas having various levels of shading or darkness that define the image. The lithophane 100 of FIG. 1 can represent these varying levels of darkness or shading in the 2-dimensional image by having portions that have varying thicknesses. For example, as seen in FIG. 2, which depicts a cross-sectional view of the lithophane 100 taken along line 110 of FIG. 1, the lithophane 100 has a first portion 102, a second portion 104, and third portion 106. Each of the portions 102, 104, 106 have varying thicknesses relative to one another, and each of the portions 102, 104, 106 correspond to the varying levels of shading or darkness of the 2-dimensional image. In this embodiment, the first portion 102 corresponds to a dark night sky in the 2-dimensional image, the second portion 104 corresponds to a bright, light-colored moon in the 2-dimensional image, and the third portion 106 corresponds to a grey-colored hill in the 2-dimensional image. It should be understood that, while the embodiments depicted in FIGS. 1-3 include three levels of thickness corresponding to three levels of shading or darkness in a 2-dimensional image, lithophanes having any number of thicknesses corresponding to any number of levels of shading in a 2-dimensional image are contemplated by the present invention.

The lithophane 100 can include any type of material, such as a thermoplastic, plastic, rubber, or silicon material. In certain embodiments, the lithophane 100 does not include a porcelain material. In the same or alternative embodiments, the lithophane 100 does not include a wax material. In one or more embodiments, the lithophane 100 can include more than one type of material, such as a thermoplastic material and a silicon material.

In one embodiment, the lithophane 100 can include a translucent material, such as a translucent thermoplastic material. Any type of translucent thermoplastic material can be used in the present invention, and a particular material can be chosen by one skilled in the art for a specific purpose. A non-limiting list of thermoplastic materials that may be present in the lithophanes of the present invention includes acrylonitrile butadiene styrene, polycarbonate-acrylonitrile butadiene styrene, polylactic acid, and polystyrene. In one or more embodiments, the lithophane 100 may include more than one type of a thermoplastic material.

In certain embodiments, the lithophane 100 has a maximum thickness dimension that is measured between an outermost surface of a front side 112 of the lithophane 100 (which in the embodiment in FIG. 1 would be the outer surface of the second portion or moon feature 104) and an outermost surface of a back side 114 of the lithophane 100 that is at least about 0.01 millimeters (mm), 0.1 mm, or 0.5 mm, and/or not more than about 5 mm, 10 mm, or 20 mm. In a preferred embodiment, the lithophane 100 has a maximum thickness between the outer surface of the front side 112 and the outer surface of the back side 114 of no more than about 3/16 of an inch, which corresponds to no more than about 4.76 mm.

The lithophane 100 has the front side 112 and the opposing back side 114. As depicted in FIG. 2, the front side 112 of the lithophane 100 can include the first, second and third portions 102, 104, 106, which have varying thicknesses and represent varying levels of shading or darkness in a 2-dimensional image. In certain embodiments, the lithophane 100 is one contiguous piece of material. For example, as in FIG. 3, which depicts a cross-sectional view of the lithophane 100 taken along the line 108, the portions 102 and 104 are integral with one another, even though they have different thicknesses. In embodiments not depicted in the figures, the lithophane 100 may include more than one object or portion, where the objects or portions are coupled together to form a lithophane.

In certain embodiments, such as that depicted in FIGS. 1-3, the back side 114 of the lithophane 100 can have a substantially uniform surface. The back side 114 having a substantially uniform surface means that the back side 114 is substantially smooth, and/or the back side 114 does not include varying thicknesses that depict a portion of a 2-dimensional image.

In the embodiment depicted in FIG. 2, a backing material 116 may be coupled to the back side 114 of the lithophane 100. The backing material 116 may be any type of visibly dark-colored material as long as it is darker than the lithophane 100. In certain embodiments, the backing material 116 may include a felt material, a paper material, a plastic material, or a paint. The backing material 116 can be coupled to the back side 114 of the lithophane 100 in any manner and a particular coupling method can be chosen by one skilled in the art for a specific purpose.

As discussed further below, in embodiments not depicted in the figures, lithophanes of the present invention (e.g., lithophane 100) can include a frame that is integral with the lithophane 100 and surrounds the outer perimeter of the lithophane 100. As further discussed below, in alternative embodiments, the lithophane 100 may include a frame attachment member that is integral with and surrounding an outer perimeter of the lithophane 100 so that a frame can be coupled thereto.

In one or more embodiments, the varying levels of shading or darkness defined by the 3-dimensional image on the front side 112 of the lithophane 100 can be visible in ambient light. In the same or alternative embodiments, the varying levels of shading or darkness defined by the 3-dimensional image of the lithophane 100 can be visible when the lithophane 100 is not backlit. Backlit means having a light source positioned behind and in close proximity to the lithophane 100.

In the presence of ambient light, one or more portions of the lithophane 100 can appear visibly darker than other portions of the lithophane 100. In embodiments where the lithophane 100 includes a translucent material, the thickness of the translucent material can be proportional to the opacity of the lithophane 100. That is, the thicker a portion of the lithophane 100, the more opaque that thicker portion appears. In various embodiments, ambient light can cause the thinner portions of the lithophane 100 to appear visibly darker than the thicker portions of the lithophane 100, when the lithophane 100 includes a dark-colored backing 116, or is in front of any object(s) that is darker than the material of the lithophane 100.

In embodiments where the lithophane 100 has a dark-colored backing 116, a thinner portion of the lithophane 100 can appear visibly darker relative to thicker portions of the lithophane 100, as a thinner portion would have a reduced opacity relative to the thicker portions and will reveal more of the dark-colored backing 116. Likewise, the thicker the portion of the lithophane 100, the visibly lighter that portion appears to the viewer relative to the thinner portions of the lithophane 100, as the thicker portions of the lithophane 100 have an increased opacity and will not reveal as much of the dark-colored backing 116. This is opposite to the construction and functioning of prior art lithophanes where thinner portions appear lighter because they let more light through.

As seen in the lithophane 100 of FIGS. 1 and 2, the thickness of the first portion 102 is reduced compared to the thicknesses of the second and third portions 104, 106, and thus, the first portion 102 will reveal more of the dark-colored backing 116 relative to the second and third portions 104, 106, thereby appearing visibly darker. Further, the second portion 104 has the greatest thickness of each of the portions 102, 104, 106, and thus, will be more opaque and will block out more of the dark-colored backing 116 than the first and third portions 102, 106, thereby appearing visibly lighter. In addition, the third portion 106 has an increased thickness relative to the first portion 102 and a reduced thickness relative to the second portion 104, and thus, will reveal more of the dark-colored backing 116 than the second portion 104 and less of the dark-colored backing 116 than the first portion 102, thereby appearing visibly lighter than the first portion 102 and visibly darker than the second portion 104.

As discussed above, the dark-colored backing 116 of the lithophane 100 need not be present to observe varying levels of darkness or shading in the portions of the lithophane 100 having varying thicknesses. For example, when the lithophane 100 of FIG. 3, which does not include a dark-colored backing 116 coupled thereto, is viewed in front of a dark-colored object(s) that is darker than the material of the lithophane 100, ambient light causes the thicker portions of the lithophane 100 to appear visibly lighter than the thinner portions of the lithophane 100. As discussed above, in embodiments where the lithophane 100 includes a translucent material, the thickness of the translucent material can correlate to the level of opacity of the lithophane 100. In such embodiments, the thicker portions of the lithophane 100 (e.g., the second portion 104) will reveal less of the dark-colored object(s) behind the lithophane 100 and appear visibly lighter, while the thinner portions (e.g., the first portion 102) will reveal more of the dark-colored object(s) behind the lithophane 100 and appear visibly darker.

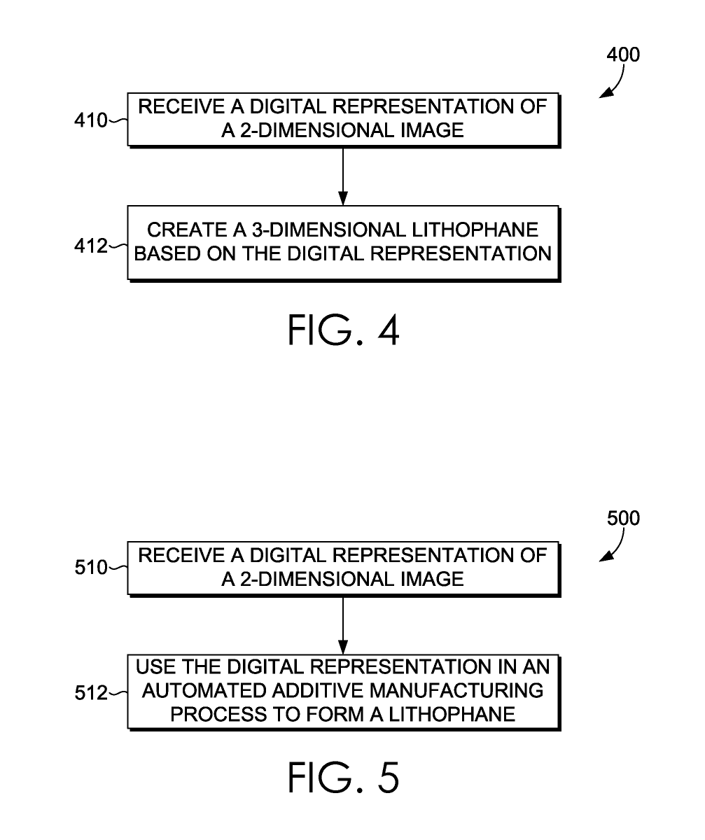

Turning now to FIG. 4, an exemplary method 400 for forming a 3-dimensional lithophane based on a 2-dimensional image is depicted. At step 410 of FIG. 4, the method includes receiving a digital representation of a 2-dimensional image. The 2-dimensional image may be any type of 2-dimensional image, such as a photograph (digital or film), video frame, scanned image, drawing, or text.

In one or more embodiments, the digital representation can be a digital file of the 2-dimensional image in any image file format commonly used in the art, such as a JPEG (Joint Photographic Experts Group), TIFF (Tagged Image File Formation), EXIF (Exchangeable Image File Format), RAW (Raw Image Formats), GIF (Graphic Interchange Format), or PNG (Portable Network Graphics) file format.

In certain embodiments, the digital representation of the 2-dimensional image may include a digital file format that is suitable for use in an automated additive manufacturing process, such as a 3-D printing process.

The step 410 of receiving a digital representation of a 2-dimensional image may include receiving the digital representation via a server, to which the digital representation has been uploaded. Alternatively, the step 410 of receiving a digital representation may include receiving the digital representation on a computer, to which the digital representation was transferred from a portable computer-readable media storage device, such as, a USB drive, SD memory card, or other portable computer-readable media.

In certain embodiments not depicted in the figures, the method 400 may include converting a digital representation into a digital file format that is compatible for use in an automated additive manufacturing process. Such conversion process may use any software readily available in the industry. The converting step may include converting the 2-dimensional image into grayscale image and then converting the grayscale image into a suitable digital file format that can be used in an automated additive manufacturing process.

The method 400 of FIG. 4 further includes the step 412 of creating a 3-dimensional lithophane based on the digital representation of a 2-dimensional image. The step 412 may include using an automated additive manufacturing process to create the lithophane. The use of an automated additive manufacturing process can result in a high-fidelity 3-dimensional representation of the original 2-dimensional image. Any automated additive manufacturing processes known to one skilled in the art may be used, such as 3-D printing. In certain embodiments, the automated additive manufacturing process may utilize at least one of a plastic, a thermoplastic, a paper, a rubber, or silicon material to create the lithophane. Any type of 3-D printing process may be used to form the lithophanes of the present invention, such as fused deposition modeling, selective heat sintering, or selective laser sintering.

Any 3-D printing machine readily available in the industry may be used to create the lithophanes of the present invention and a particular machine can be chosen by one skilled in the art for a specific purpose. In certain embodiments, an automated additive manufacturing device (e.g., a 3-D printing machine) may have a Z-resolution (layer thickness) of at least about 1 nanometer (nm), 10 nm, or 100 nm, and/or not more than about 500 micrometers (μm), 250 μm, or 100 μm. In the same or alternative embodiments, an automated additive manufacturing device (e.g., a 3-D printing machine) may have an X-Y resolution of at least about 1 μm, 5 μm, or 10 μm, and/or not more than about 500 μm, 300 μm, or 200 μm.

Utilizing an automated additive manufacturing process to create a lithophane can allow, in certain embodiments, for the method 400 to include creating a plurality of lithophanes. In such embodiments, each of the plurality of lithophanes may be distinct 3-dimensional representations of different 2-dimensional images.

The lithophanes produced as a result of the method 400 of FIG. 4 may include all the properties and parameters of the lithophanes (e.g., the lithophane 100) discussed above with reference to FIGS. 1-3. For example, the lithophanes produced using the method 400 may have the thickness ranges discussed above with respect to FIG. 1.

As discussed above with reference to FIG. 2, the lithophanes of the present invention may include a visibly dark-colored material (e.g., the backing 116 of FIG. 2) coupled to the back side of the lithophane. In such embodiments, the method 400 may further include coupling a visibly dark-colored material to the back side of the lithophane, with the visibly dark-colored material being visibly darker than the lithophane. The visibly dark-colored material can include any of the materials discussed above with reference to the backing 116 of FIG. 2. Such a material may be coupled to the lithophane in any manner known to one skilled in the art and the particular coupling method may depend upon the type of backing material and/or the specific lithophane manufacturing process utilized.

In certain embodiments, the method 400 of FIG. 4 can include forming a frame on the outside perimeter of the lithophane. In such embodiments, the frame can be formed via the same automated additive manufacturing process used to create the lithophane. In various embodiments, the frame may be integral with the lithophane. Alternatively, the frame may be separate from the lithophane and coupled to the lithophane after the lithophane is formed.

In one or more embodiments, the method 400 of FIG. 4 may include forming a frame attachment member on the outside perimeter of the lithophane. For example, during the automated additive manufacturing process, a frame attachment member may be created that is integral with the lithophane, which can then be utilized to attach a frame thereto. The frame attachment member can be any type of mechanism known in the art that is capable of attaching a lithophane to a frame, such as a tongue and groove-type joint.

Turning now to FIG. 5, an exemplary method 500 for forming a 3-dimensional lithophane based on a 2-dimensional image is depicted. The method 500 includes a step 510 of receiving a digital representation of a 2-dimensional image. The step 510 can include all the properties and parameters discussed above with reference to the step 410 of the method 400 of FIG. 4. Further, as discussed above with reference to the method 400 of FIG. 4, the method 500 can include a step of converting a digital representation of a 2-dimensional image into a digital file format capable of being used in an automated additive manufacturing process.

The method 500 further includes a step 512 of using a digital representation in an automated additive manufacturing process to form a lithophane. The automated manufacturing process can include the use of an automated additive manufacturing device, such as one or more of the devices discussed above with reference to the step 412 of FIG. 4.

As discussed above, the digital representation can be a digital file suitable for use in an automated additive manufacturing process. Accordingly, in certain embodiments, the step 512 of using a digital representation in an automated additive manufacturing process to form a lithophane may include transmitting, uploading, or downloading the digital representation onto a computing device that controls an automated additive manufacturing device or directly transmitting, uploading, or downloading the digital representation onto an automated additive manufacturing device itself. Such a digital representation may include information necessary to form a 3-dimensional representation of a 2-dimensional image.

Like the method 400 of FIG. 4, the method 500 of FIG. 5 can also include forming a frame or frame attachment member for the resulting lithophane. Further, like the method 400, the method 500 can include creating a plurality of lithophanes where each lithophane is distinct and is a representation of a different 2-dimensional image.

From the foregoing it will be seen that this invention is one well adapted to attain all ends and objects hereinabove set forth together with the other advantages which are clear following the complete disclosure above and which are inherent to the methods and apparatuses described herein. It will be understood that certain features and subcombinations are of utility and may be employed without reference to other features and subcombinations. This is contemplated by and is within the scope of the invention and claims.

Since many possible embodiments may be made of the invention without departing from the scope thereof, it is to be understood that all matter herein set forth or shown in the accompanying drawings is to be interpreted as illustrative of applications of the principles of this invention, and not in a limiting sense.

The invention claimed is:

1. A method for forming a 3-dimensional lithophane based on a 2-dimensional image, the method comprising:
receiving a digital representation of a 2-dimensional image, the 2-dimensional image comprising at least one visibly light portion and at least one visibly dark portion, wherein the at least one visibly dark portion is visibly darker than the at least one visibly light portion; and
creating a 3-dimensional lithophane based on the digital representation, the lithophane comprising opposing front and back sides, the front side comprising at least a first portion and a second portion, the second portion having a thickness dimension that is greater than a thickness dimension of the first portion, wherein the first portion of the lithophane corresponds to the at least one visibly dark portion of the 2-dimensional image, and wherein the second portion of the lithophane corresponds to the at least one visibly light portion of the 2-dimensional image.

2. The method according to claim 1, wherein the creating a 3-dimensional lithophane comprises the use of an automated additive manufacturing process.

3. The method according to claim 2, wherein the automated additive manufacturing process comprises 3-D printing.

4. The method according to claim 1, wherein ambient light causes the first portion of the lithophane to appear visibly darker than the second portion of the lithophane.

5. The method according to claim 1, further comprising coupling a visibly dark-colored material to the back side of the lithophane, wherein the visibly dark-colored material is visibly darker than the lithophane.

6. The method according to claim 5, wherein the visibly dark-colored material comprises one of a plastic material, paper material, felt material, or a paint.

7. The method according to claim 1, wherein the lithophane has a maximum thickness dimension measured between an outermost surface of the front side and an outermost surface of the back side of at least about 0.01 mm and not more than about 20 mm.

8. The method according to claim 1, wherein the lithophane does not comprise a porcelain material.

9. The method according to claim 1, wherein the lithophane comprises a thermoplastic material.

10. A method for forming a 3-dimensional lithophane based on a 2-dimensional image, the method comprising:
receiving a digital representation of a 2-dimensional image, the 2-dimensional image comprising a first area having a first level of shading and a second area having a second level of shading, the first level of shading being visibly lighter than the second level of shading, whereby the first and second areas define at least a portion of the 2-dimensional image; and
using the digital representation in an automated additive manufacturing process to form a lithophane, the lithophane comprising a first and a second portion, the first portion having a first thickness and the second portion having a second thickness, the first thickness being greater than the second thickness, wherein the first thickness corresponds to the first area of the 2-dimensional image and the second thickness corresponds to the second area of the 2-dimensional image.

11. The method according to claim 10, wherein the automated additive manufacturing process comprises 3-D printing.

12. The method according to claim 10, wherein the lithophane comprises a front side and an opposing back side, the front side comprising the first and second thicknesses, wherein the method further comprises coupling a visibly dark-colored material to the back side of the lithophane, and wherein the visibly dark-colored material is visibly darker than the lithophane.

13. The method according to claim 10, wherein ambient light causes the second portion of the lithophane to appear visibly darker than the first portion of the lithophane.

14. The method according to claim 10, wherein the lithophane comprises a thermoplastic material.

15. A 3-dimensional lithophane based on a 2-dimensional image, the lithophane comprising:
a front side and an opposing back side, the front side comprising a 3-dimensional representation of a 2-dimensional image, wherein the 2-dimensional image comprises a first area and a second area that define at least a portion of the 2-dimensional image, the first area having a first level of shading and the second area having a second level of shading, the first level of shading being visibly lighter than the second level of shading, wherein the 3-dimenional representation comprises a first portion and a second portion, the first portion having a first thickness and the second portion having a second thickness, the first thickness being greater than the second thickness, wherein the first portion of the lithophane corresponds to the first area of the 2-dimensional image and the second portion of the lithophane corresponds to the second area of the 2-dimensional image.

16. The lithophane according to claim 15, wherein the back side of the lithophane comprises an outer surface that is substantially uniform.

17. The lithophane according to claim 15, further comprising a visibly dark-colored material coupled to the back side of the lithophane, wherein the visibly dark-colored material is visibly darker than the lithophane.

18. The lithophane according to claim 15, wherein the lithophane has a maximum thickness dimension measured between an outermost surface of the front side and an outermost surface of the back side and wherein the maximum thickness dimension is at least about 0.01 mm and not more than about 20 mm.

19. The lithophane according to claim 15, wherein ambient light causes the second portion of the lithophane to appear visibly darker than the first portion of the lithophane.

20. The lithophane according to claim 15, wherein the lithophane comprises a thermoplastic material.
